(19) United States
(12) Patent Application Publication
(10) Pub. No.: US 2003/0233653 A1
(43) Pub. Date: Dec. 18, 2003

(54) Virtual channel mapping and channel tuning method in digital broadcasting

(76) Inventors: Jeong Shik Hwang, Seoul (KR); Jung Ryol Kim, Seoul (KR); Myung Deog Jang, Seoul (KR)

Correspondence Address: HARNESS, DICKEY & PIERCE, P.L.C., P.O. BOX 828, BLOOMFIELD HILLS, MI, 48303, US

(21) Appl. No.: 10/269,494

(22) Filed: Oct. 11, 2002

(30) Foreign Application Priority Data
Jun. 12, 2002 (KR) 2002-32953

(51) Int. Cl. G06F 3/00; H04N 5/445; G06F 13/00; H04N 5/44

(52) U.S. Cl. 725/38; 348/734

(57) ABSTRACT

A virtual channel mapping and channel tuning method in digital broadcasting is disclosed. Particularly, it relates to a technology that makes it possible for users to select a desirous digital broadcasting channel simply by using a hot-key on a remote controller, which is the same in every locality in a country, by using a virtual channel function.

The virtual channel mapping method comprises the steps of: automatically searching for the channels or manually changing the channels to find a desirous channel; if the searched channel is a digital channel, analyzing the digital stream to check the existence of virtual channel information or a broadcasting station title corresponding to a certain hot-key; if virtual channel information exists, updating channel map information for the searched virtual channel and a remote controller hot-key to be mapped into each other and storing the information; and if a broadcasting station title exists, updating channel map information for the searched broadcasting station title and a remote controller hot-key to be mapped into each other and storing the information.

### BACKGROUND OF THE INVENTION

1. Field of the Invention

The present invention relates to a virtual channel mapping and channel tuning method in digital broadcasting. Particularly, it relates to a technology that stores information on digital channels, maps the information into corresponding hot-keys of a remote controller, and thereby makes it possible for a user to select a desirous digital broadcasting channel by simply pressing a corresponding hot-key without memorizing the channel numbers of various broadcasting companies.

2. Description of the Related Art

Ever since the analog color TV broadcasting was being started, the screen size has been continuously increased. With the size increase, however, the demand for high-definition screen strongly arises since the conventional broadcasting system cannot provide a sufficient screen quality. So, a new broadcasting standard has been being required, and as a result, a digital-type high-definition TV(HDTV) technology has been recently developed.

With the advantages of digital technology, the frequency using efficiency is improved so that sufficient numbers of broadcasting channels can be created. Furthermore, by handling all the signals in a digital-way, high-definition screen and high-quality voice can be achieved. Since a digital broadcasting receiver handles video/audio signals in digital data, it is being changed to be a two-way multimedia instrument, capable of exchanging information data, and carrying out the function of home information terminal. So, a digital broadcasting receiver is currently being developed to provide various convenient functions for users to enjoy the advantages of digital technology.

Looking into an example of analog channel mapping described in FIG. 1, it allocates RF channel bands, set by Federal Communication Committee(FCC), into channel numbers, where each channel takes 6 MHz band. For example, if a user selects channel 16 by a remote controller to watch MBC in the conventional analog system, it seeks for the center frequency of channel 16 band, 482-488 MHz, and thereafter demodulates the modulated signals to display on the screen.

The frequency band mapping described in FIG. 1 is only an example and it can vary in different localities. For example, KBS may be mapped into channel 14 in Seoul but into channel 18 in Busan.

In other words, as described in FIG. 2, a transmission station A may transmit a certain broadcasting program in channel 16 whereas another transmission station B transmits the same broadcasting program in channel 30. Therefore, a user should be well aware of the channel numbers of desirous broadcastings according to their residence, and in the case of watching TV in a different locality without having the information of regional channel allocation, he(or she) has to wander around the channels to find a desirous broadcasting since the channel numbers may be different in a different locality.

Besides, in case of a user watching a cable TV, the channels can also be varied through re-transmission at a cable station office(SO). For example, as described in FIG. 3, channel 16 may be re-transmitted in channel 44 at cable SO B while it is re-transmitted in channel 83 at cable SO A. And thus, a user should be well aware of the channel numbers according to the corresponding cable SO.

### SUMMARY OF THE INVENTION

The present invention is proposed to solve the problems of the prior art mentioned above. It is therefore the object of the present invention to provide a method that makes it possible for a user to select a desirous digital broadcasting channel simply by using a hot-key equipped on a remote controller, which is the same in every locality in a country, by using a virtual channel function, one of the advantageous characteristics of digital technology.

In other words, it stores information on digital channels, maps the information into corresponding hotkeys on a remote controller, and thereby makes it possible for a user to select a desirous digital broadcasting channel by simply pressing a corresponding hot-key.

To achieve the object mentioned above, the present invention presents a virtual channel mapping method in digital broadcasting for mapping virtual channels of various broadcasting companies into hot-keys equipped on a digital broadcasting remote controller, characterized by comprising the steps of: automatically searching for the channels or manually changing the channels to find a desirous channel; in case that the searched channel is a digital channel, analyzing the digital stream to check the existence of virtual channel information or a broadcasting station title corresponding to a certain hot-key; if virtual channel information exists, updating channel map information for the searched virtual channel and a hot-key of a remote controller to be mapped into each other and storing the information; and if a broadcasting station title exists, updating channel map information for the searched broadcasting station title and a hot-key of a remote controller to be mapped into each other and storing the information.

### BRIEF DESCRIPTION OF THE DRAWINGS

FIG. 1 is a view illustrating an example of an analog channel frequency mapping in the prior art.

FIG. 2 and FIG. 3 are views illustrating examples of transmitting the allocated analog channel frequencies in the prior art.

FIG. 4 is a view illustrating an example of a virtual channel frequency mapping in accordance with the present invention.

FIG. 5 and FIG. 6 are views illustrating examples of transmitting the frequency-mapped virtual channels.

FIG. 7 is a view illustrating an embodiment of a remote controller equipped with hot-keys for digital broadcasting channels in accordance with the present invention.

FIG. 8 is a flowchart showing the procedures of mapping digital channels of various broadcasting companies into hot-keys of a remote controller in accordance with the present invention.

FIG. 9 is a flowchart showing the procedures of, when a user presses a hot-key on a remote controller, moving into the selected digital channel and displaying the selected broadcasting in accordance with the present invention.

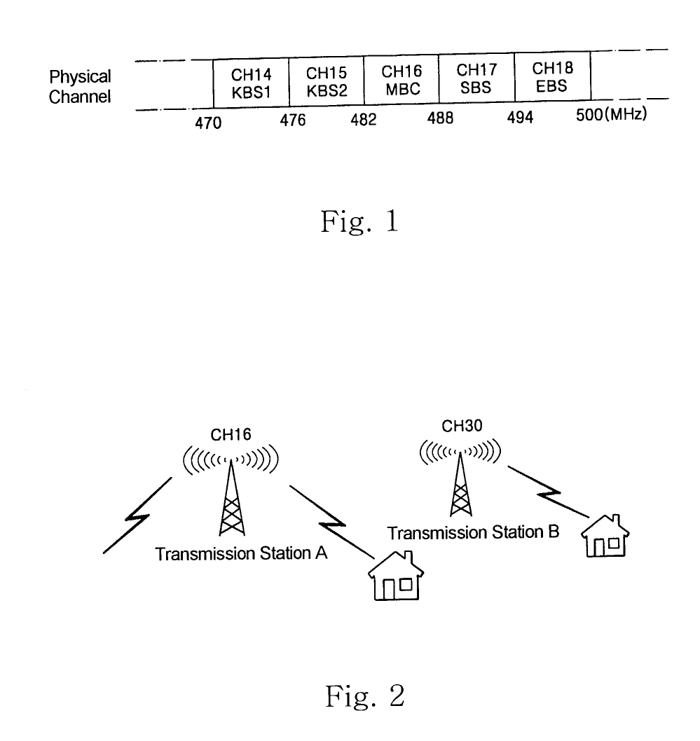

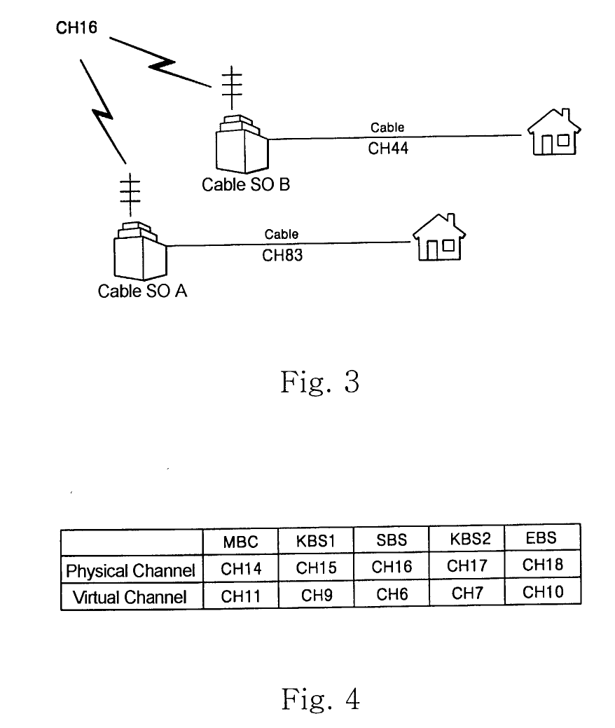

### DETAILED DESCRIPTION OF THE EMBODIMENTS

Hereinafter, referring to appended drawings, the structure and operation principles of an embodiment of the present invention are described in detail.

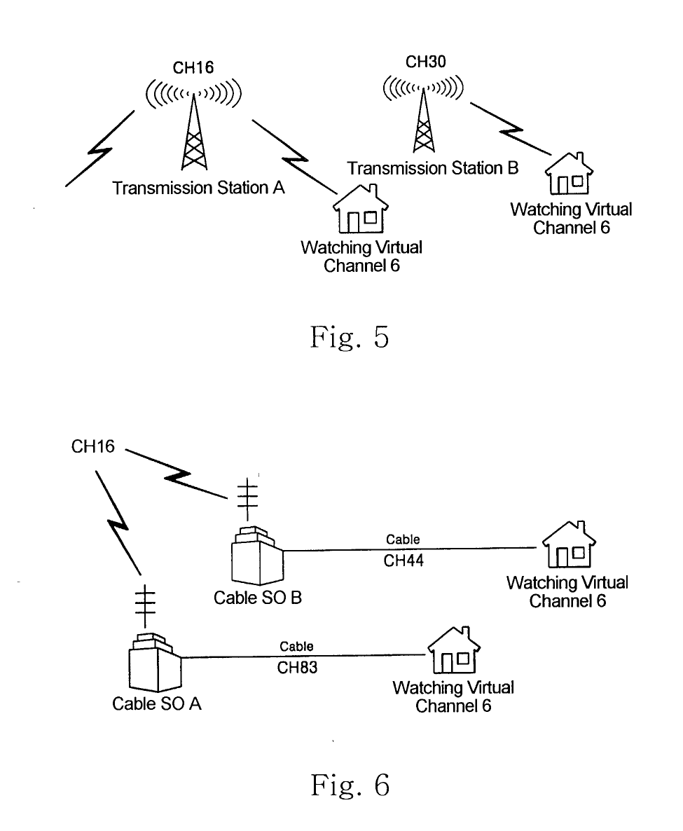

FIG. 4 is a view illustrating an example of a virtual channel frequency mapping in accordance with the present invention. And FIG. 5 and FIG. 6 are views illustrating examples of transmitting the frequency-mapped virtual channels.

Under the prior analog broadcasting system, users are watching TV by the channels transmitted by each local transmission station. However, it is possible to watch TV by virtual channels, regardless of transmission station channels, under digital TV(DTV) broadcasting system. For example, as described in FIG. 5 and FIG. 6, users can watch SBS digital broadcasting simply by selecting virtual channel 6 at any locality in the country regardless of directly receiving the broadcasting by an antenna or receiving it by a cable re-transmission.

In other words, even though the physical channel of SBS digital broadcasting from transmission station A(CH 16) is different from that from transmission station B(CH 30), users can watch SBS digital broadcasting simply by selecting virtual channel 6, which is characteristically allocated to SBS digital broadcasting, at any locality in the country.

In more detail, in case of PSIP(Program Service Information Protocol) of ATSC(Advanced Television Service Committee), which is the standard of terrestrial digital broadcasting, a virtual channel is composed of a major channel number and minor channel numbers. A major channel number is a channel number allocated to the 6 MHz band used for terrestrial broadcasting and minor channel numbers are channel numbers allocated to the digital service channels transmitted through the 6 MHz band.

As described above, digital channel system does not use high-frequency channel numbers for channel tuning like an analog system but uses major channel numbers, each of which is a characteristic number allocated to each broadcasting company. And in case that a broadcasting company broadcasts multi-channels, it supplementarily uses minor channel numbers self-allocated by the broadcasting company. A Major number is allocated to each broadcasting company with a characteristic number. Currently, CH 6 is allocated to SBS, CH 9 is to KBS1, CH 7 is to KBS2, CH 11 is to MBC, and CH 10 is to EBS as described in FIG. 4.

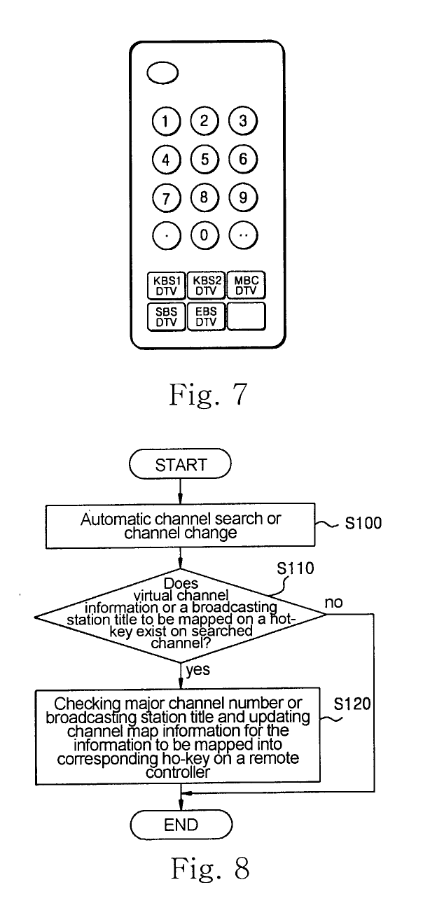

Since a characteristic virtual channel is allocated to each broadcasting company in digital broadcasting system, users can watch a specific broadcasting with the same virtual channel number at any locality in the country even though the corresponding physical channel is different from one another at each locality. Thus, it is the key concept of the present invention, by using the advantageous characteristic of digital broadcasting just mentioned above, to install hot-keys, each of which is corresponding to a digital broadcasting channel of each broadcasting company, on a remote controller as described in FIG. 7, for users to watch a desirous digital broadcasting easily without memorizing all the digital broadcasting channel numbers.

With this feature, even a user without having the information on virtual channels as well as physical channels of digital broadcasting can watch a desirous digital broadcasting by simply pressing a hot-key on a remote controller, and thus the using convenience can be maximized. Moreover, even in the case of physical channels being changed later, users still can watch a desirous digital broadcasting by simply pressing a hot-key on a remote controller just like before the change since an internally-installed program of a digital broadcasting receiver automatically maps the changed physical channels into the corresponding hotkeys.

FIG. 8 is a flowchart showing the procedures of mapping digital channels of various broadcasting companies into hot-keys on a remote controller in accordance with the present invention. This method can be applied to a digital set-top box or a digital TV internally equipped with set-top box function.

When a user initially uses a digital set-top box, he(or she) uses automatic channel search function or manually varies the channel for finding desirous channels(S100).

At this stage, if the searched channel is a digital channel, it analyzes the digital stream to check the existence of virtual channel information or a broadcasting station title corresponding to a certain hot-key(S110)

That is to say, if the searched channel is a digital channel and the virtual channel information corresponding to a certain hot-key exists, it updates channel map information for the searched virtual channel and a hot-key of a remote controller to be mapped into each other and stores the information.

It also analyzes the digital stream to obtain the information on a broadcasting station title, and if there exists any information corresponding to a certain hot-key of a remote controller, it updates the mapping(S120). For example, if the title of broadcasting station is “MBC DTV”, it maps the channel into a hot-key, MBC DTV, on a remote controller.

Here, the system updates the information with the latest one whenever being changed into digital channels. And thus, users can watch a desirous digital broadcasting by using the same hot-key, owing to the automatic update of mapping information, even when the physical channel of the digital channel is changed.

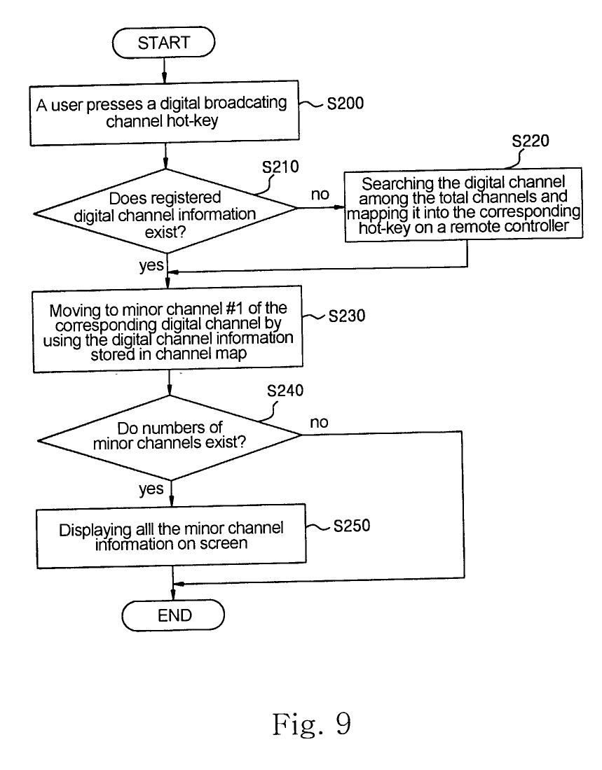

FIG. 9 is a flowchart showing the procedures of, when a user presses a hot-key on a remote controller, moving into the selected digital channel and displaying the selected broadcasting in accordance with the present invention.

First, if a user presses a digital channel hot-key on a remote controller(S200), it searches the stored channel map information to check the existence of digital channel information corresponding to the hot-key selected by the user(S210).

In case that the digital channel corresponding to the hot-key is not registered, it informs the user that it is not registered yet, searches the digital channel among the total channels, and maps it into the hot-key on a remote controller(S220). This procedure is being carried out only once when there is no information registered on a hot-key.

In case that the digital channel corresponding to the hot-key is registered, it tunes the corresponding digital channel by using the information and displays minor channel #1 of the digital channel by default(S230).

At this stage, it checks whether minor channels exist in the selected channel(S240). If so, it informs all the minor channel information to the user. And then, whenever the user presses the same hot-key in the selected channel, it moves to next minor channel of the major channel(S250).

In case that the major channel of “MBC DTV” is CH 11 and 4 minor channels exist such as 11-1, 11-2, 11-3, and 11-4, for example, if the channel is first changed into “MBC DTV” from other channel by the hot-key of “MBC DTV” being pressed, it displays the channel 11-1 by default.

And then, if the hot-key of “MBC DTV” is pressed again in the channel, it moves to the next minor channel recursively by the turn of 11-1 [symbol] 11-2 [symbol] 11-3 [symbol] 11-4 [symbol] 11-1 [symbol] . . . .

As mentioned thereinbefore, the present invention provides a virtual channel mapping and channel tuning method in digital broadcasting that stores information on digital channels, maps the information into corresponding hot-keys on a remote controller, and thereby makes it possible for users to select a desirous digital broadcasting channel by simply pressing a corresponding hot-key without memorizing the channel numbers of various broadcasting companies.

In addition, it provides the convenience that a user can watch a desirous digital broadcasting channel by simply pressing the same hot-key, even when the physical channel of a digital channel is changed, by automatically re-mapping the hot-keys using the virtual channel information.

Since those having ordinary knowledge and skill in the art of the present invention will recognize additional modifications and applications within the scope thereof, the present invention is not limited to the embodiments and drawings described above.

What is claimed is:

1. A virtual channel mapping method in digital broadcasting for mapping virtual channels of various broadcasting companies into hot-keys equipped on a digital broadcasting remote controller, characterized by comprising the steps of:
automatically searching for the channels or manually changing the channels to find a desirous channel;
in case that said searched channel is a digital channel, analyzing the digital stream to check the existence of virtual channel information or a broadcasting station title corresponding to a certain hot-key; and
if virtual channel information exists, updating channel map information for said searched virtual channel and said hot-key of said remote controller to be mapped into each other and storing the information.

2. A virtual channel mapping method in digital broadcasting as claimed in claim 1,
characterized by further comprising the step of, if a broadcasting station title exists, updating channel map information for said searched broadcasting station title and said hot-key of said remote controller to be mapped into each other and storing the information.

3. A virtual channel mapping method in digital broadcasting as claimed in claim 1,
characterized by, if any changed information different from previously stored information in channel map is found during said step of digital channel searching, re-updating channel map for said changed information to be automatically mapped into hot-keys of said remote controller.

4. A channel tuning method in digital broadcasting for tuning the corresponding channel when a digital channel hot-key equipped on a remote controller is selected, characterized by comprising the steps of:
searching stored digital channel map when a user presses a digital channel hot-key on a remote controller;
in case that the digital channel information corresponding to said hot-key on a remote controller exists, moving to minor channel #1 of said digital channel by using virtual channel tuning information stored in said channel map;
in case that numbers of minor channels exist in said digital channel, informing all the minor channel information to a user; and
moving to next minor channel of said digital channel whenever a user presses the same hot-key in the same major channel.

5. A channel tuning method in digital broadcasting as claimed in claim 1,
characterized by further comprising the step of, in case that the digital channel information corresponding to said hot-key on a remote controller does not exist, informing this to a user, searching said digital channel among the total channels, and mapping said digital channel into said hot-key on said remote controller.
